(19) United States
(12) Patent Application Publication
(10) Pub. No.: US 2024/0230156 A9
(43) Pub. Date: Jul. 11, 2024

(54) PTC Heating Element, Electric Heating Device and Use of a PTC Heating Element

(71) Applicant: TDK Electronics AG, München (DE)

(72) Inventors: Markus Koini, Seiersberg (AT); Michael Krenn, Dobl-Zwaring (AT); Markus Puff, Graz (AT); Stephan Bigl, Graz (AT)

(21) Appl. No.: 18/546,555

(22) PCT Filed: Feb. 14, 2022
(86) PCT No.: PCT/EP2022/053499

§ 371 Date: Aug. 15, 2023

(30) Foreign Application Priority Data
Feb. 15, 2021 (DE) 10 2021 103 480.9

(51) Int. Cl. F24H 3/04; F24H 9/1863; H05B 3/26

(52) U.S. Cl. CPC F24H 3/0447; F24H 9/1872; H05B 3/265; H05B 3/267; F24H 2250/04; H05B 2203/02

(57) ABSTRACT

A PTC heating element for an electric heater having a PTC element, an electrode formed on a surface of the PTC element for electrically contacting the PTC element, at least one additional contact for electrically connecting the electrode of the PTC element, and a carrier layer. The carrier layer is electrically insulating, the thickness of the PTC element is ≤500 μm, and the installation height of the PTC heating element is between 500 μm and 2500 μm. Also disclosed is an electric heater and use of the PTC heating element in a motor vehicle.

The present invention relates to a heating element, in particular a PTC heating element. The present invention further relates to an electric heating device comprising the PTC heating element. The present invention further relates to the use of the PTC heating element in a motor vehicle, for example in an electric vehicle.

Heating coils equipped with PTC (Positive Temperature Coefficient) heating elements have the advantage that, due to their temperature-dependent resistance, the power consumption is automatically limited when a certain temperature is reached. This feature not only serves as a safety feature to prevent overloading of the heating register, but also to make the control very simple through the self-regulating effect.

The use in electric vehicles suggests to operate the register directly with the high-voltage battery (200-400 V, sometimes also 800 V). This means that the insulation strength must be designed accordingly. Usually, PTC elements are electrically contacted on two opposite sides by means of a conductor track. The conductor track is supported by a substrate, which couples out the heat generated on the other side.

The heat output that can be decoupled depends strongly on the thermal path through the layer structure described above. Heat must travel from the point of origin (the PTC) via the contacting and through the substrate to the decoupling surface. Here, thermal and electrical considerations for optimizing the heater are often subject to opposing arguments, i.e. state-of-the-art designs are compromise solutions between power density, thermal agility and insulation capability or robustness and reliability.

For example, the fact that the manufacturer of the PTC elements and the manufacturer of the heating elements are not the same means that the PTC element has to meet certain requirements in terms of geometric tolerances, transportability and handleability in the assembly process. Thus, a certain minimum thickness of the PTC elements cannot be undercut within reasonable effort.

It would also be thermally optimal to connect the PTC element directly to the (metallic) heat sink. However, since electrical insulation must be provided in a high-voltage system (230 V-800 V), an electrically non-conductive barrier is required to sufficiently decouple the system voltage from the radiator. In addition, clearances and creepage distances (usually 4 mm for high-voltage heaters in electric vehicles) between different polarities must be maintained, which can only be accomplished by using insulation materials.

The PTC element itself acts as a heat source when Joule's heat is generated by energization. However, this is not generated homogeneously in the material, but depending on the geometry and possible material inhomogeneities the electric field distribution in the component can cause a temperature gradient. Starting from hotspots, the heat must first reach the surface of the elements before it can be transported further. Due to the relatively poor thermal conductivity of PTC ceramics (usually ˜5 W/mK), this can happen very slowly and sluggishly.

Document EP 3 101 999 A1 describes a PTC heating element for an electrical heating device for a motor vehicle, which is electrically insulated on the outside in an improved manner, also taking into account the need for adequate heat transfer from the PTC element to the heat-emitting surface through the electrical insulating layer. For this purpose, an electrical insulating layer is provided which abuts the outside of at least one of the conductive tracks via which the PTC element is energized and comprises a foil and an electrically insulating compound with good thermal conductivity applied thereto.

Document US 2017/0223776 A1 describes an electrical heating device having at least one PTC electrical heating element and radiation fins located on the outer surface of the PTC electrical heating element. The surface on the radiation fins that is not in contact with the electric PTC heating element is not charged. An insulation layer is provided between conductive tracks and the radiation fins.

Also, document DE 11 2017 006 124 T5 describes an electric heating device with insulation layer between conductor tracks and the cooling fins. The electric heater has a plurality of PTC elements and heat radiating fins for radiating heat transferred starting from the PTC elements, a resin plate for insulating the electrode plates, and a compression spring which presses a laminated body starting from both sides in a lamination direction.

The document EP 1 182 908 B1 describes a PTC heating device with at least one PTC element and two contact plates which contact the PTC element. To connect the surface of the PTC element with the contact plates, a metal foil is provided, which is coated with adhesive on both sides. Insulation of the contact plates is not provided.

The link https://air-lab.de/index.html describes heating elements with direct contact on aluminum cooling fins for optimum heat extraction. Electrical insulation is not provided in this case.

It is the object of the present invention to describe a PTC heating element and an electric heating device which solve the above problems.

This object is solved by a PTC heating element, an electric heating device as well as the use of the PTC heating element according to the independent claims.

According to one aspect, a PTC heating element is described. The PTC heating element is adapted to be integrated in an electrical heating device, for example in a heating register. The PTC heating element is adapted for use in a motor vehicle, for example in an electric vehicle (xEV—x Electrical Vehicle).

The PTC heating element has at least one PTC element. Preferably, the PTC heating element has a plurality of PTC elements, for example five, ten or 20 PTC elements. A cavity between two successive PTC elements may be filled with a temperature-resistant filler material. The filler material acts as a mechanical protection or barrier against moisture penetration and as an additional heat conductor (instead of air).

The PTC element is used to generate heat. The PTC element has at least one electrode, in particular two electrodes, for electrical contacting. The electrodes are provided on a surface of the PTC element.

The PTC heating element further has at least one further contact. The further contact serves for the electrical connection of the electrode of the PTC element. The further contact can, for example, comprise copper, aluminum and/or tungsten.

The PTC heating element further comprises at least one carrier layer. The carrier layer surrounds the PTC elements at least partially, preferably completely. The carrier layer is electrically insulating. The carrier layer has a high thermal conductivity. The carrier layer serves to mechanically stabilize and electrically insulate the PTC heating element.

The PTC heating element is very compact. The PTC heating element has a large surface area and is thin. The PTC heating element has an extremely small volume. A thickness of the PTC element is preferably ≤500 μm, preferably ≤250 μm, for example 10 μm to 150 μm or even <2 μm. A height of the PTC heating element is between 500 μm and 2500 μm. A lateral dimension of the PTC heating element is preferably between 10 mm and 250 mm in both directions (length and width).

Preferably, the PTC heating element is designed plane-parallel. In particular, the carrier layer is preferably designed to be plane-parallel. Preferably, the PTC element is also designed plane-parallel.

The better defined the surface of the substrate/the carrier layer is, the thinner and more efficient the thermal transition (e.g. to an aluminum heat sink) can be. Specifically, this means for the PTC element (˜27×13 mm)<100 μm, ideally: <30 μm; (AlN or AlOₓ)-carrier layer: (165×35 mm): 500 μm, ideally: <100 μm.

The flatness and plane parallelism of the PTC elements and the carrier layer is important for the performance of the PTC heating element. If the surfaces of at least one PTC element/the carrier layer are not appropriately well defined, the gap must be filled with leveling compound or potting compound, which increases the thermal resistance. The more precisely the components are manufactured, the thinner the gap.

Preferably, the at least one PTC element is very thin and in particular has a thickness <250 μm, with a plane parallelism <100 μm. Particularly preferably, the plane parallelism of the PTC element is <30 μm. Preferably, the carrier layer has a plane parallelism <500 μm, particularly preferably <100 μm.

The composition of the PTC heating element described above allows an extremely compact design, which in turn allows a high level of integration into an electric heating device.

This ensures a faster and more efficient heating effect (e.g. in the interior of a vehicle) compared to prior art heating devices. Weight savings resulting from lower material usage enable an increase in the range of xEVs while the low material consumption contributes to resource conservation and reduction of the ecological footprint.

By suitable combination of materials and/or joining techniques—together with the optimization of the geometry on heating element level—the volume of the PTC heating element and the heat extraction are optimized in such a way that the power density, the thermal response as well as the robustness and reliability are significantly improved compared to the state of the art.

According to one embodiment, the electrodes are arranged in an areal manner on the surface of the at least one PTC element. The electrodes are provided directly on the surface of the PTC element. The electrodes can be sputtered, galvanized, printed or doctored onto the surface of the PTC element.

The electrodes are designed with as large an area as possible in order to achieve a favorable heat extraction. The electrodes can, for example, be strip-shaped, rectangular, comb-shaped or have an interdigital structure. The electrodes must be sufficiently spaced from one another to keep creepage distances free and thus prevent electrical flashover. This provides a particularly reliable PTC heating element.

For example, at least one electrode is arranged on a top side or a bottom side of the PTC element. Two electrodes may also be provided on the top side or the bottom side. One electrode can also be provided on the top side and one on the bottom side.

Alternatively, the electrodes may be provided on side surfaces, particularly opposite side surfaces, of the PTC element. This separates the thermal and electrical paths from each other and enables new designs and assemblies that may be advantageous for certain manufacturers. In addition, production-related material inhomogeneities in the PTC element can be better controlled or bypassed.

According to one embodiment, the further contact is self-supporting. In other words, the carrier layer merely stabilizes the other components of the PTC heating element. The carrier layer, on the other hand, is not (absolutely) necessary for stabilizing the further contact.

Alternatively, the further contact can also be applied to the carrier layer for mechanical stabilization. For example, the further contact can be sputtered, printed or doctored onto the carrier layer.

According to one embodiment, the further contact is integrated into the carrier layer. In other words, the further contact is provided in an inner region of the carrier layer. In this case, the further contact is arranged ≤50 μm below a surface of the carrier layer.

According to one embodiment, a geometry of the further contact is adapted to a geometry of the electrode of the PTC element. For example, the further contact is designed to be as large-area and thin as possible. For example, a thickness of the further contact is <10 μm. This can increase the heat extraction of the PTC heating element and thus increase efficiency.

According to one embodiment, the further contact is electrically conductively connected to the at least one electrode by means of clamping, sintering, bonding or high-temperature brazing. By using standard connection techniques, manufacturing costs can be reduced and thus a particularly cost-effective PTC heating element can be provided.

According to one embodiment, the carrier layer has a thickness between 150 μm and 1000 μm. Thus, the carrier layer is designed very compact and thin to optimize the power density of the PTC heating element, but thick enough to ensure the robustness and stability of the PTC heating element.

According to one embodiment, the carrier layer comprises a ceramic material with high thermal conductivity and good insulation properties. For example, the carrier layer comprises AlN, Si₃N₄, Al₂O₃, or SiC. These materials are ideal for optimizing heat extraction and thus increasing the power density and thermal response of the PTC heating element.

Alternatively, the carrier layer may comprise a temperature-resistant plastic. For example, the carrier layer comprises polyimide or epoxy resin. Due to the low thermal conductivity (<10 W/mK) of plastic, a thickness of the carrier layer must be sufficiently thin to keep the thermal resistance low and thus achieve a high power density of the PTC heating element.

Alternatively, the carrier layer may comprise a hybrid solution based on a ceramic material and plastic. For example, the carrier layer can comprise a plastic layer and a ceramic layer. To achieve optimum heat extraction, the plastic layer must be significantly thinner than the ceramic layer.

According to one embodiment, the PTC heating element further has at least one metallic layer on a surface of the carrier layer. The metallic layer is used for further contacting of the PTC heating element, for example for connection to a radiator. The metallic layer may comprise Cu, Al or W, for example. The metallic layer is very thin. Preferably, the metallic layer has a thickness between 1 μm and 100 μm. Due to the low thickness of the metallic layer, the thermal decoupling of the PTC heating element is not negatively influenced.

According to one embodiment, the at least one PTC element comprises a ceramic material, a metallic-ceramic material or an organic-ceramic material. For example, the PTC element comprises PZT (lead zirconate titanate). By using standard materials, a particularly cost-effective PTC heating element can be achieved.

Alternatively, the PTC element can be based on bismuth. This has the advantage that the PTC element is lead-free. Alternatively, the PTC element can also have a bismuth- and lead-free material.

According to one embodiment, a material of the at least one PTC element has a low specific resistance. For example, the specific resistance is <5000 Ω cm, for example 1000 Ω cm. As a result, the PTC effect below the operating point can be significantly reduced and thus the power consumption/inrush current can be significantly reduced at each turn-on operation compared to more conventional HV PTCs. This not only leads to a lower load (lower inrush current) on the other electronic components but also leads to a further increase in the range of electric cars.

According to one embodiment, the PTC element is a low-temperature PTC element. This has the particular advantage that corresponding PTC elements can be manufactured entirely from bismuth- and lead-free materials.

According to one embodiment, the PTC heating element has a plurality of PTC elements. The PTC elements are arranged adjacent to each other or following each other on the carrier layer. In particular, PTC elements are arranged successively in a direction along a main longitudinal axis X of the heating element. Furthermore, PTC elements are arranged successively in a direction perpendicular to the main longitudinal axis X (i.e. along a transverse axis Y).

Due to the design, a cavity occurs between successive PTC elements. A cavity between two successive PTC elements can be filled with an electrode for electrical contacting of the respective PTC element. In particular, the cavities running along the main longitudinal axis X can be filled with electrode material.

This means that contacting opposite side surfaces of the respective PTC element is made by the electrodes. In other words, the PTC elements are contacted from one end face of the PTC elements. In this case, the top side and bottom side of the PTC element are free of electrodes. This separates the thermal and electrical paths and allows for new designs and assemblies that may be advantageous to certain manufacturers. In addition, material inhomogeneities in the PTC element caused by manufacturing can be better controlled or bypassed.

The remaining cavities between the PTC elements that are not filled with electrode material (cavities perpendicular to the main longitudinal direction) can, for example, be filled with the filler material described above, to improve thermal contact between the PTC elements.

According to one embodiment, the PTC heating element has a plurality of further contacts. The further contacts are provided directly on the carrier layer. In other words, no further component of the PTC heating element is arranged between the further contacts and the carrier layer.

The respective further contact is, for example, strip-shaped. Preferably, the further contacts are formed as metallization strips of the carrier layer. Preferably, a further contact extends completely along the main longitudinal direction of the PTC heating element.

The further contacts can be provided alternately above and below the PTC elements (in particular the electrodes). This ensures reliable contacting of the electrodes of the PTC elements.

According to one embodiment, the PTC heating element further comprises at least one connecting element for electrical connection between the at least one PTC element and the at least one further contact. Preferably, the PTC heating element comprises a plurality of connecting elements.

The at least one connecting element can be strip-shaped. The respective connecting element preferably extends at least partially along the main longitudinal direction of the PTC heating element. The respective connecting element is provided at least between the respective further contact and the respective electrode. The respective connecting element is in direct contact with an electrode of at least one PTC element. The connecting element is also in direct contact with at least one, preferably with exactly one, further contact. Preferably, the at least one connecting element comprises a conductive adhesive.

With the connecting element, an electrically conductive and mechanically firm connection between the electrodes and the further contact can be ensured in a simple manner.

According to a further aspect, an electric heating device, for example a heating register, is described. The electric heating device comprises a component having heat emitting surfaces, for example cooling fins. The electric heating device further comprises at least one PTC heating element, preferably the PTC heating element described above. All properties disclosed with respect to the PTC heating element are consequently also disclosed correspondingly with respect to the respective other aspect and vice versa, even if the respective property is not explicitly mentioned in the context of the respective aspect.

The optimized design of the PTC heating element ensures a high level of integration in the heating device. This enables a fast and efficient heating effect (e.g. in the interior of a vehicle).

According to a further aspect, the use of the PTC heating element described above in a motor vehicle, for example in an electric vehicle, is described. The PTC heating element has an extremely compact design and is thus suitable for any installation situation. Furthermore, the PTC heating element can ensure optimum heat extraction and thus high power density and reliability.

The drawings described below are not to be understood as true to scale. Rather, individual dimensions may be enlarged, reduced or even distorted for better representation.

Elements that are similar to each other or that perform the same function are designated with the same reference signs. It show:

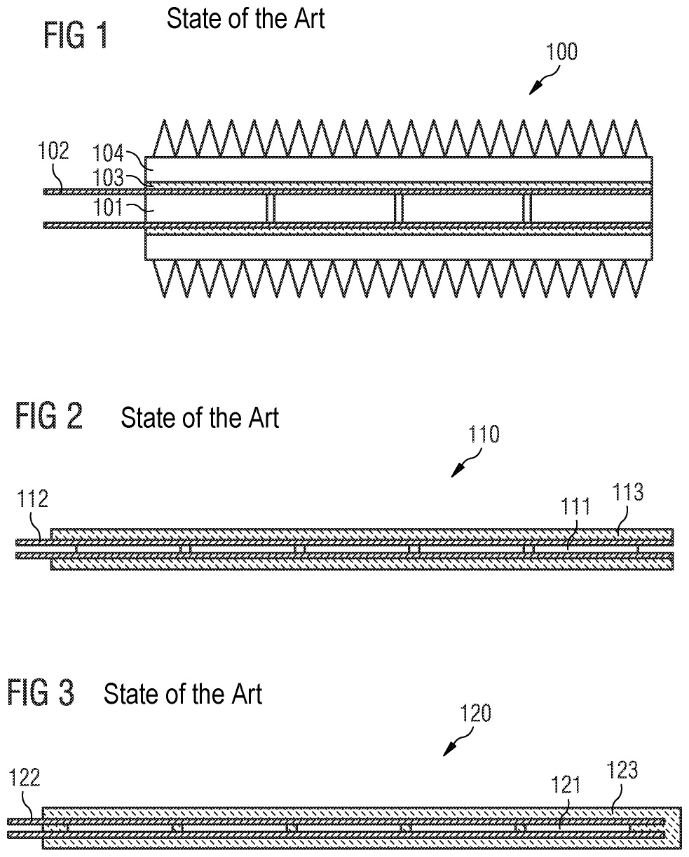

FIG. 1 a PTC heating element according to the state of the art.

FIG. 2 another PTC heating element according to the state of the art.

FIG. 3 another heating element according to the state of the art.

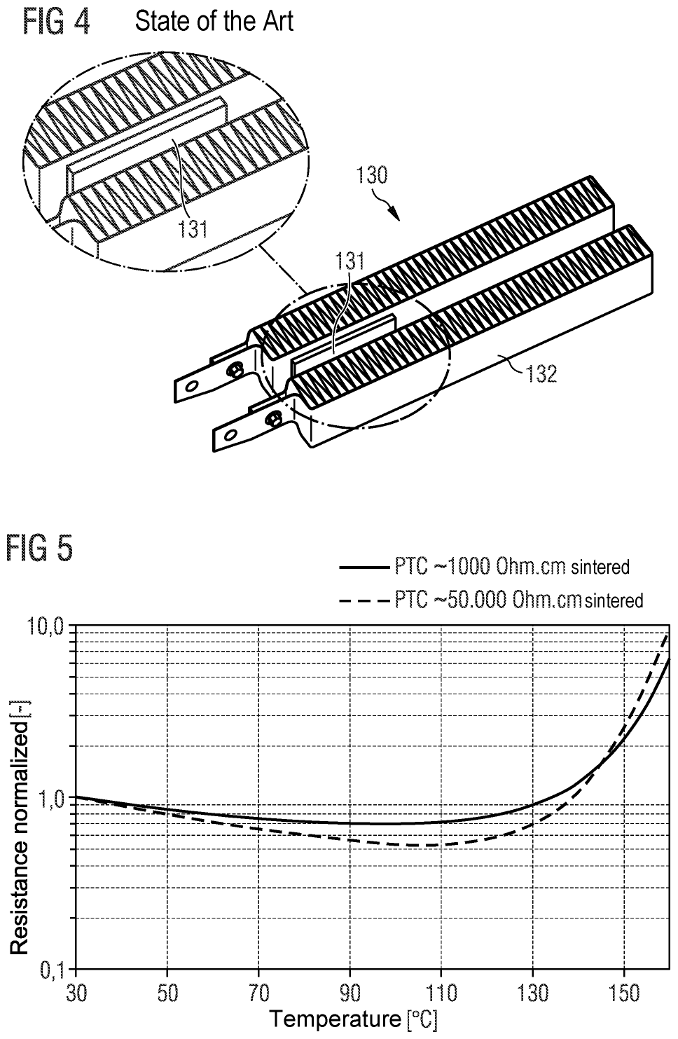

FIG. 4 another heating element according to the state of the art.

FIG. 5 ther esistance-temperature behavior of a HV PTC ceramic at two different specific resistances.

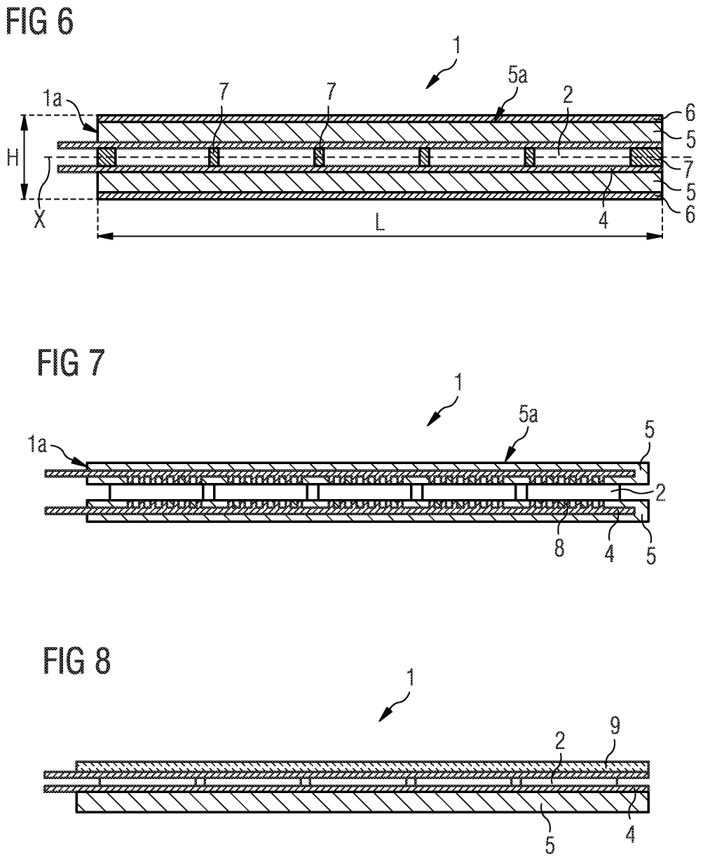

FIG. 6 a sectional view of a PTC heating element according to a first embodiment.

FIG. 7 a sectional view of a PTC heating element according to a further embodiment.

FIG. 8 a sectional view of a PTC heating element according to a further embodiment.

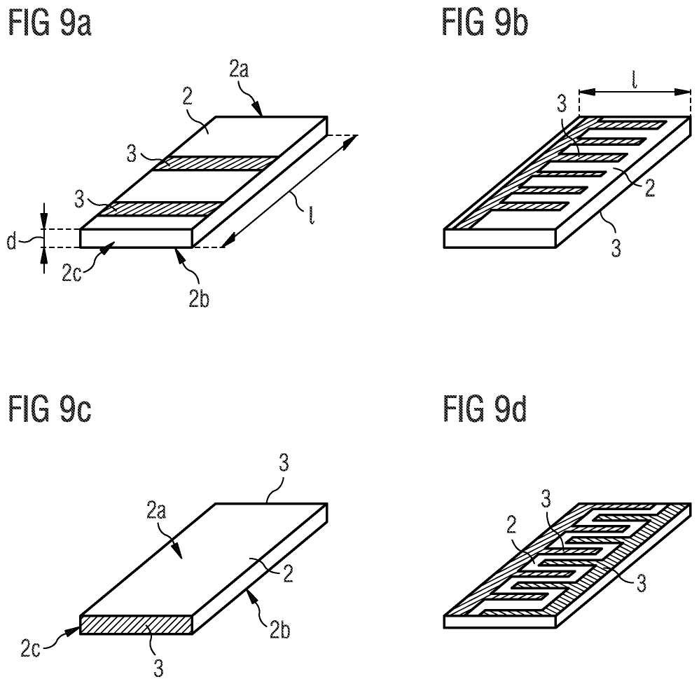

FIGS. 9a to 9d perspective views of PTC elements for a PTC heating element.

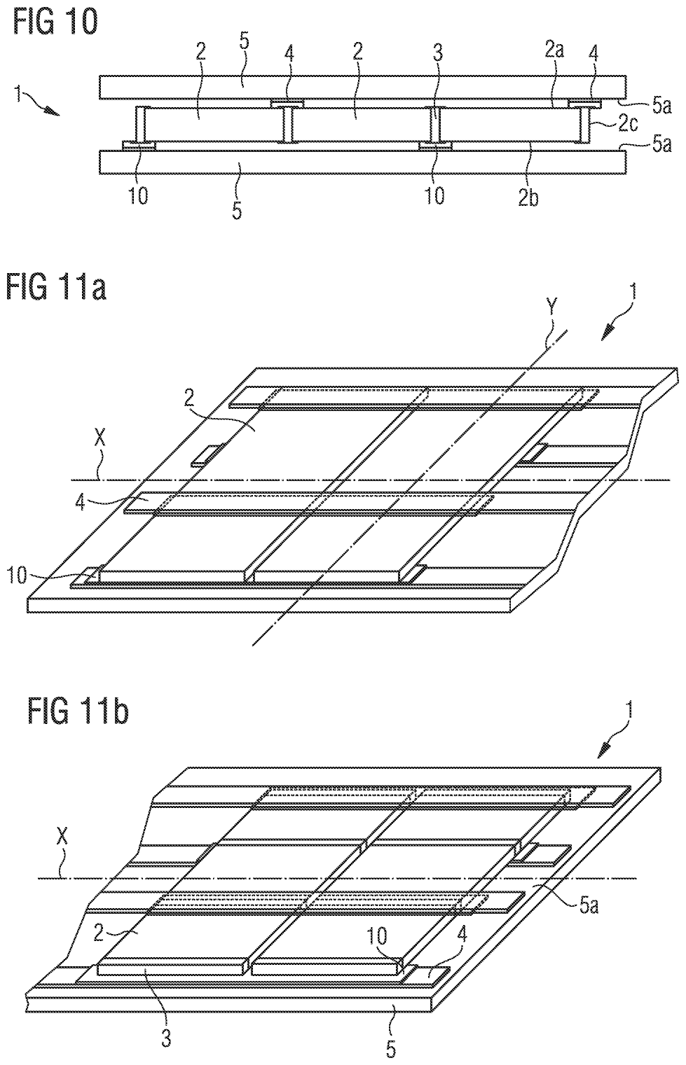

FIG. 10 a sectional view of a PTC heating element according to a further embodiment.

FIG. 11a a perspective view of a partial area of the PTC heating element according to FIG. 6.

FIG. 11b a perspective view of a partial area of the PTC heating element according to FIG. 10.

FIG. 1 shows a sectional view of a prior art PTC heating element 100. The PTC heating element 100 has a plurality (four in this embodiment) of PTC elements 101 for generating heat. The PTC elements 101 are arranged in succession in the longitudinal direction of the PTC heating element 100 and are separated from one another by an air gap.

Electrical contacts 102 (made of copper, for example) are disposed on a top side and bottom side of the PTC elements 101 for electrically connecting the PTC elements 101.

The PTC heating element 100 further includes insulation layers 103 disposed on the electrical contacts 102 to electrically insulate the PTC heating element 100 from the outside and, in particular, from heat distributors or radiators 104 arranged on an outer surface of the PTC electrical heating element 100.

FIG. 2 shows a sectional view of another prior art PTC heating element 110. Here, the PTC elements 111 are again arranged between electrical contacts 112. An insulation layer 113 of plastic (for example polyimide) is formed on the electrical contacts 112 for electrical insulation of the heating element 110.

FIG. 3 shows a sectional view of another prior art PTC heating element 120. The PTC elements 121 are connected by means of electrical contacts 122 and insulated from the outside by a plastic molding 123 (for example epoxy resin). The PTC elements 121 are completely surrounded by the molding 123.

FIG. 4 shows a sectional view of a further prior art PTC heating element 130. Here, the PTC elements 131 are in direct contact with the radiator 132 to achieve optimum heat extraction. There is no electrical insulation.

FIG. 6 shows a sectional view of a PTC heating element 1 according to a first embodiment. The PTC heating element 1 is adapted for use in a motor vehicle, for example in an electric vehicle. The PTC heating element 1 is adapted to be integrated into an electrical device (for example an electrical heating device) with a radiator or a heat sink (not explicitly shown).

The PTC heating element 1 has a plurality of PTC elements 2 (see also FIGS. 9a to 9d). The PTC heating element 1 also has electrodes/electrical contacts 3, further contacts/conductors 4 and a carrier layer/substrate 5.

The PTC elements 2 serve as a heat source. In particular, Joule's heat is generated by energizing the PTC elements 2. In this embodiment, the heating element 1 has five PTC elements 2. Of course, more than five PTC elements 2, for example eight or ten PTC elements 2, or less than five PTC elements 2, for example two PTC elements 2 or one PTC element 2 may be provided. The number of PTC elements 2 depends, among other things, on the requirements for the PTC heating element 1, its material composition and the installation situation, for example in a motor vehicle.

The PTC elements 2 are arranged successively or sequentially along a main longitudinal axis X of the PTC heating element 1. They comprise a ceramic material, a metallic-ceramic material or an organic-ceramic material. For example, the PTC elements have a PZT ceramic. An alternative bismuth-based composition is also conceivable. This has the advantage that the PTC elements 2 can be formed lead-free. A completely lead- and bismuth-free composition of the PTC elements 2 is also conceivable.

Due to the design, cavities perpendicular to the main longitudinal axis X may occur between the PTC elements 2. In this embodiment, these cavities are filled with a temperature-resistant and thermally conductive filler material 7, for example silicone or epoxy. The optional filling material 7 acts as a mechanical protection or barrier against moisture penetration and as an additional heat conductor (instead of air).

The respective PTC element 2 is very compact. In particular, a thickness d or extension perpendicular to the main longitudinal axis X (see also FIG. 9a) of the respective PTC element 2 is between 50 μm and 250 μm. Preferably, the thickness d of the respective PTC element 2 is <200 μm.

In order to achieve a corresponding thickness d, the respective PTC element 2 can be manufactured using a standard process (press process or multilayer structure). However, alternative manufacturing methods can also be used to produce even thinner PTC elements 2 (10 μm to 150 μm or even ≤2 μm). For example, thinner PTC layers can be obtained by applying them to the carrier layer 5 by means of screen printing, whereby a thickness d of the respective PTC element 2 between 10 μm and 150 μm can be achieved. These layer thicknesses can be further reduced by application processes such as SolGel, inkjet printing or plasma jet processes to achieve a thickness d<2 μm.

A lateral extension 1 (extension along as well as transverse to the main longitudinal axis X) of the respective PTC element 2 is preferably between 5 mm and 100 mm (FIGS. 9a and 9b).

For the electrical connection of the respective PTC element 2, the PTC element 2 has an electrical contact or electrodes 3, as can be seen in FIGS. 9a to 9d. The electrodes 3 are formed in an areal manner on a surface 2a, 2b, 2c of the respective PTC element 2. The electrodes 3 are formed to have an area as large as possible in order to achieve a favorable heat extraction. The electrodes 3 of opposite polarity must also be sufficiently spaced apart to prevent electrical flashovers.

One electrode 3 can be provided on a bottom side 2b and one on a top side 2a of the PTC element 2 (FIG. 9b). However, two electrodes 3 can also be provided on the top side 2a and the bottom side of the PTC element 2 can be free of electrodes 3 (FIGS. 9a and 9d) or vice versa.

It is also possible to contact, for example, opposite side surfaces 2c of the respective PTC element 2 through the electrodes 3, as can be seen in FIG. 9c. In this case, the top side 2a and the bottom side 2b are free of electrodes 3. Thus, the thermal and electrical paths are separated and new designs and assemblies that may be advantageous for certain manufacturers are enabled. In addition, material inhomogeneities in the PTC element 2 due to manufacturing become more manageable or bypassable. An embodiment for a PTC heating element 1 with correspondingly contacted PTC elements 2 can be found in FIGS. 10 and 11b.

The electrodes 3 are designed with as large a surface area as possible while complying with the creepage distances (usually 4 mm for high-voltage heaters). The electrodes 3 at least partially cover the top side 2a or the bottom side 2b of the PTC element. If the electrodes 3 are arranged on the side surfaces 2c, the side surfaces 2c can also be completely covered by the electrodes 3. For example, the electrodes are strip-shaped or rectangular (FIGS. 9a and 9c). A comb-like or an interdigitated structure is also possible (FIGS. 9b and 9d). In the case of interdigitated electrode structures, particular care must be taken to ensure that the distance between the electrodes 3 is sufficiently dimensioned to avoid electrical flashovers.

The electrodes 3 comprise an electrically conductive material (for example a metal paste). The electrically conductive material is sputtered, printed or doctored onto the surface 2a, 2b, 2c of the respective PTC element 2. Preferably, the electrodes 3 are realized by means of a sputter layer, or a metal firing paste.

By using the described electrode configurations (see FIGS. 9a to 9d), other specific resistances are required with respect to the PTC material compared to the state of the art. This additional degree of freedom means that with lower specific resistances, the PTC effect below the operating point is noticeably reduced and thus the energy consumption or inrush current is significantly reduced for each switch-on process compared to more conventional HV (High Voltage) PTCs. This leads to a lower load (lower inrush current).

FIG. 5 illustrates standardized curves (same measuring voltage) showing the resistance-temperature behavior of an HV PTC ceramic at two different specific resistances. Due to the lower specific resistance, the resistance drop is significantly reduced compared to the conventional higher specific resistance.

In order to electrically contact the electrodes 3, the PTC heating element 1 further comprises the above-mentioned conductive conductors or further contacts 4. In this embodiment, the conductors or further contacts 4 extend along the top side 2a and the bottom side 2b of the PTC elements 2 through the PTC heating element 1. In other words, the further contacts 4 according to FIG. 6 are provided between the PTC elements 2 (or the electrodes 3) and the carrier layer 5. In particular, the further contacts 4 are in direct contact with the electrodes 3 of the PTC elements 2.

The further contacts 4 extend along the main longitudinal axis X. The further contacts 4 protrude from the PTC heating element 1 at a side surface 1a for the electrical connection of the PTC heating element 1.

An electrically conductive connection between the electrodes 3 and the further contacts 4 can be realized using a variety of technical solutions. Clamp contacting is just as possible as a connection using sintering techniques (μAg, μCu or TLPS (Transient Liquid Phase Sintering)) or high-temperature soldering.

The further contacts 4 can be self-supporting. This means that no further element (for example the carrier layer or substrate 5) is required for mechanical stabilization of the respective further contact 4. Alternatively, the further contacts 4 may be applied to the carrier layer 5. In this case, the further contacts 4 are sputtered, galvanized, printed or doctored onto the carrier layer 5. As mentioned above, the further contacts 4 in the two designs mentioned are in direct electrical and mechanical contact with the electrodes 3, as can be seen in FIG. 6.

The further contacts 4 comprise, for example, copper, aluminum or tungsten. However, other electrically conductive metals, alloys or other electrically conductive materials are also conceivable for the further contacts 4. A geometry of the respective further contact 4 is adapted to that of the electrodes 3 of the PTC elements 2 in such a way that no field overshoots or flashovers occur during operation of the PTC element 2.

Preferably, the further contact 4 has a large surface area. The respective further contact 4 is as thin as possible in order to save installation space. Preferably, a thickness of the further contacts 4 is <10 μm. This is possible in particular if the further contacts 4 are applied to the carrier layer 5 by sputtering, printing or doctoring, as already mentioned above.

The PTC heating element 1 further comprises the carrier layer 5 already introduced. The carrier layer 5 serves to electrically insulate the PTC heating element 1 from the outside and to mechanically stabilize the PTC heating element 1. The PTC elements 2 are arranged completely in an inner area of the carrier layer 5. The further contacts 4 are also at least partially embedded in the carrier layer 5.

The carrier layer 5 has a very low thickness (extension perpendicular to the main longitudinal axis X). For example, the thickness of the carrier layer 5 is between 150 μm and 1000 μm. This allows any heat due to ohmic losses at the feed line but also the heat transfer of the heating element to be conducted to the outside as efficiently as possible.

The carrier layer 5 further comprises a material with high thermal conductivity and good electrical insulation properties. In this embodiment, the carrier layer 5 comprises a ceramic material, for example AlN, Si₃N₄, Al₂O₃ or SiC. By use of carrier layers 5 with particularly good thermal conductivity (e.g., for AlN: up to 200 W/mK) the conductor cross-section for electrical contacting can also be reduced, since heat due to the ohmic losses can be dissipated immediately through the carrier layer 5.

In an alternative embodiment, the carrier layer 5 can also comprise a temperature-resistant plastic (e.g., polyimide or epoxy resin). In this case, due to the low thermal conductivity (<10 W/mK) of the plastic, the thickness of the carrier layer 5 must be so thin that the thermal resistance remains small enough.

In other words, a plastic carrier layer 5 must be made much thinner than a ceramic carrier layer. In particular, the plastic layer must be thin enough to guarantee thermal transport, but thick enough to guarantee electrical insulation and mechanical stability of the PTC heating element 1. For example, a carrier layer 5 made of plastic has a thickness of 50 μm. The electrical feed line (electrodes 3, further contacts 4) can also act as a heat spreader here in order to maximize the area that contributes to heat conduction in the carrier layer 5.

A hybrid solution for the carrier layer based on ceramic and plastic is also possible (see later on description of FIG. 8).

Furthermore, a metallic layer 6 is provided on the surface 5a of the carrier layer 5 in this embodiment. The metallic layer 6 completely covers a top side and a bottom side of the carrier layer 5. The metallic layer 6 facilitates mechanical and thermal contacting of a (metallic) radiator or heat sink (not explicitly shown). The metallic layer 6 is formed very thin. For example, a thickness of the metallic layer 6 is between 1 μm and 100 μm. The metallic layer 6 comprises Cu, Al or W.

In total, an overall height H of the PTC heating element 1 is between 500 μm and 2500 μm due to the design described above. The lateral dimensions L of the PTC heating element 1 are between 10 mm and 250 mm in both directions (lateral dimensions L: length, i.e. extension along the main longitudinal axis X as well as width, i.e. extension transverse to the main longitudinal axis X).

The PTC heating element 1 is thus extremely compact, in particular large-area and thin. By means of a suitable combination of the materials and connection techniques described above, together with the optimization of the geometry at the heating element level, the volume of the PTC heating element 1 and the heat extraction are optimized in such a way that the power density, thermal response, robustness and reliability are significantly improved compared to the state of the art.

Due to the very efficient, thin and powerful design of the PTC heating element 1 it is also possible to use low-temperature PTCs. These can be manufactured from completely bismuth and lead-free materials.

FIG. 7 shows a sectional view of a PTC heating element 1 according to a further embodiment. In contrast to the embodiment shown in FIG. 6, the further contacts 4 are not provided between the carrier layer 5 and the PTC elements 2. Rather, the further contacts 4 are integrated into the carrier layer 5. Only at the side surface 1a of the PTC heating element 1 the further contacts 4 protrude from the carrier layer 5 in order to ensure the electrical connection of the PTC heating element 1.

In this embodiment, the carrier layer 5 preferably comprises AlN. The respective further contact 4 comprises a tungsten (W) layer. In other words, the further contacts 4 embedded in the carrier layer 5 are preferably realized by W-contacts in an AlN carrier layer 5. The W layer preferably has a thickness of 5-20 μm. The W layer is preferably implemented over a large area in the carrier layer 5.

As already explained in connection with FIG. 6, the carrier layer 5 has a typical thickness of 150 μm-1000 μm. The W-layer can be formed symmetrically in a central region of the carrier layer 5 or offset towards the central region. In the embodiment according to FIG. 7, the respective further contact 4 (W layer) is formed offset from the center area of the carrier layer 5 towards the PTC elements 2. In any case, the W-layer is arranged at least 50 μm below a surface of the carrier layer 5.

In this embodiment, the PTC heating element 1 further comprises feedthroughs/vias 8. Preferably, the vias 8 comprise tungsten. Preferably, the vias 8 are made of tungsten. However, the vias 8 may also comprise or consist of other electrically conductive materials.

The vias 8 completely penetrate the carrier layer 5 in a direction perpendicular to the main longitudinal axis X of the PTC heating element 1. The vias 8 establish an electrically conductive connection between the W layers (further contacts 4) and the electrodes 3 of the PTC elements 2.

With regard to the properties or the further components/characteristics of the PTC heating element 1, reference is made to the description in connection with FIG. 6.

FIG. 8 shows a sectional view of a PTC heating element 1 according to a further embodiment. In this embodiment, the carrier layer 5 comprises a hybrid solution based on ceramic and on plastic materials. In particular, the PTC heating element 1 has on one side (here the top side) a layer of temperature-resistant plastic 9 (e.g., polyimide or epoxy resin). On the opposite side (here bottom side) the PTC heating element 1 has a carrier layer 5 of ceramic material—as already described in connection with FIG. 6. Of course, the plastic 9 can also be formed on the bottom side and the ceramic carrier material can be formed on the top side.

The ceramic carrier layer 5 is used for mechanical stabilization and insulation of the PTC heating element 1 (in this case insulation of the bottom side). The plastic layer 9 serves to insulate the PTC heating element 1 (in this case insulation of the top side). Both layers must be of sufficient thickness to ensure electrical insulation but thin enough to ensure thermal transport. In particular, due to the low thermal conductivity (≤10 W/mK) of the plastic, the thickness of the plastic layer 9 must be thin enough to keep the thermal resistance small enough, as already described in connection with the embodiment according to FIG. 6.

In particular, the plastic layer 9 is thinner than the ceramic layer 5. For example, in this embodiment, the thickness of the ceramic carrier layer 5 is ten to one hundred times greater than the thickness of the plastic layer 9. The plastic layer 9 has a thickness of between 2 μm and 50 μm. For example, the thickness of the plastic layer is 30 μm. The ceramic carrier layer 5 has a thickness between 0.5 mm and 1 mm to ensure the mechanical stability of the PTC heating element 1.

With regard to the further properties or the further components/characteristics of the PTC heating element 1, reference is made to the description in connection with FIG. 6.

FIG. 11a shows a representation of a PTC heating element 1 according to the above embodiments. In particular, FIG. 11a shows a plurality of PTC elements 2 arranged in succession along the main longitudinal axis X of the heating element 1. The PTC elements 2 are contacted respectively from the top side 2a and the bottom side 2b via electrodes 3 (see in particular FIGS. 6a, 9a, 9b and 9d).

The electrodes 3 are connected from the top side 2a or the bottom side 2b of the PTC elements 2 via strip-shaped further contacts 4. A connecting element 10, for example a conductive adhesive, is provided between the electrodes 3 and the further contacts 4, which establishes an electrical and mechanical connection between the further contacts 4 and the electrodes 3.

Furthermore, a filler material 7 may be placed in the cavity between two successive PTC elements 2 (not explicitly shown, see FIG. 6).

FIGS. 10 and 11b show an illustration of a PTC heating element 1 according to a further embodiment. As already described above, the PTC heating element 1 is designed for use in a motor vehicle, for example in an electric vehicle. The PTC heating element 1 is adapted to be integrated into an electrical device (for example an electrical heating device) with a radiator or a heat sink (not explicitly shown).

The PTC heating element 1 has electrodes/electrical contacts 3, further contacts 4 and a carrier layer/substrate 5. The carrier layer 5 preferably comprises a ceramic. The PTC heating element 1 further comprises connecting elements 10, as will be described in more detail below.

The PTC heating element 1 has a plurality of PTC elements 2. Compared to the above embodiments (see in particular also FIG. 11a), the PTC elements 2 have a smaller extension perpendicular to the main longitudinal axis X of the PTC heating element 1. In other words, the PTC 2 elements according to FIGS. 10 and 11a have a shorter length than, for example, the PTC elements 2 according to FIG. 11a.

The PTC elements 2 are arranged adjacent to each other or following each other on the carrier layer 5. In particular, a plurality of PTC elements 2 are arranged successively in the direction along the main longitudinal axis X of the heater 1. Further, PTC elements 2 are arranged successively in a direction perpendicular to the main longitudinal axis X (i.e., along a transverse axis Y).

Cavities occur between the PTC elements 2 due to their design, as already described in connection with FIG. 6 (see also FIG. 11a). In this embodiment, the cavities run parallel and transverse to the main longitudinal axis X (see FIG. 11b).

The cavities transverse to the main longitudinal axis X can be filled with a temperature-resistant filler material 7, as in the embodiment described above (not explicitly shown, see in particular FIG. 6). This can improve the thermal contact between the PTC elements 2.

In the embodiment according to FIGS. 10 and 11b, the cavities parallel to the main longitudinal axis X are further filled with electrode material. In other words, in the respective cavity running along the main longitudinal axis X between two PTC elements 2 following each other in the direction perpendicular to the main longitudinal axis X (i.e. along the transverse axis Y), an electrode 3 is formed, respectively, for electrically contacting the two PTC elements 2.

The respective electrode 3 represents a metallization. The respective electrode 3 completely covers the side surface 2c (in particular a short side surface) of the respective PTC element 2 (see also the embodiment according to FIG. 9c). In other words, in the embodiment according to FIGS. 10 and 11b, the contacting of the PTC elements 2 takes place from an end face of the PTC elements 2. In contrast thereto, in the embodiments described above (see, for example, FIGS. 6 and 11a), contacting of the PTC elements 2 takes place from the top side 2a and/or the bottom side 2b of the PTC elements 2.

The respective electrode 3 or metallization completely fills the cavity between the PTC elements 2. Electrodes 3 with opposite polarity are arranged alternately. This means that a first cavity between two PTC elements 2 following each other in the direction along the transverse axis Y is filled with an electrode 3 of a first polarity. A second cavity following in the direction along the transverse axis Y is filled with an electrode 3 of the opposite polarity. Two successive PTC elements 2 always share an electrode 3 or metallization, i.e., they are contacted by a common metallization. In order to electrically contact the electrodes 3, the PTC heating element 1 further comprises the above-mentioned further contact 4, in particular a plurality of further contacts 4. The further contacts 4 are provided between the PTC elements 2 (in particular the electrodes 3) and the carrier layer 5.

It follows from this that the further contacts 4 are formed in particular at an interface between two PTC elements 2 following one another in the direction of the transverse axis Y. In other words, the further contacts 4 cover at least the cavities filled with electrode material that run along or parallel to the main longitudinal axis X.

The further contacts 4 are arranged alternately on the top side 2a and the bottom side 2b of the PTC elements 2 (see also FIG. 11a). The further contacts 4 formed on the top side 2a establish an electrical connection to the end-face electrodes 3 of a first polarity. The further contacts 4 formed on the bottom side 2b establish an electrical connection to the and-face electrodes 3 of the opposite polarity.

The further contacts 4 are strip-shaped. The further contacts 4 extend completely along the main longitudinal axis X. The individual further contacts 4 are formed parallel to each other along the main longitudinal axis X.

The further contacts 4 can protrude from the PTC heating element 1 on a side surface 1a (see FIG. 6) for electrical contacting of the heating element 1. The further contacts 4 represent a metallization of the carrier layer 5. In particular, the further contacts 4 in this embodiment correspond to metallization strips on a surface 5a of the carrier layer 5. The further contacts 4 are in direct contact with the carrier layer 5.

An electrically conductive connection between the electrodes 3 and the further contacts 4 is realized via the connecting elements 10. The respective connecting element 10 comprises a conductive adhesive, for example.

The connecting elements 10 are provided between the PTC elements 2 (in particular the electrodes 3) and the further contacts 4. In particular, the connecting elements 10 are in direct contact with the electrodes 3 (here on the face side) of the PTC elements 2 and the further contacts 4. The connecting elements 10 are designed in strip form. The respective connecting element 10 extends at least partially along the main longitudinal axis X.

In the embodiment according to FIGS. 10 and 11b, a respective connecting element 10 is formed at the interface between two PTC elements 2 that follow one another in the direction of the transverse axis Y. In other words, the respective connecting element 10 covers at least one cavity filled with electrode material, which runs parallel to the main longitudinal axis X. Of course, the connecting elements 10 can also be formed longer, so that they extend over several cavities and thus over more than two PTC elements 2 (not explicitly shown).

With regard to all further features concerning the PTC elements 2, the carrier layer 5, the further contacts 4 and the electrodes 3, in particular also with regard to the composition and the dimensions of the components, reference is made to the above description.

The description of the objects disclosed herein is not limited to the individual specific embodiments. Rather, the features of the individual embodiments can be combined with each other as desired—as far as technically reasonable.

### LIST OF REFERENCE SIGNS

1 PTC heating element
1a Side surface of the PTC heating element
2 PTC element
2a Top side of the PTC element
2b Bottom side of the PTC element
2c Side surface of the PTC element
3 Electrode
4 Further contact
5 Carrier layer
5a Surface of the carrier layer
6 Metallic layer
7 Filler material
8 Via
9 Plastic
10 Connecting element
l Length of the PTC element
d Thickness of the PTC element
H Height of the PTC heating element
L Lateral dimension of the PTC heating element
X Main longitudinal axis of the PTC heating element
Y Transverse axis of the PTC heating element
100 PTC heating element
101 PTC element
102 Electrical contact
103 Insulation layer
104 Radiator
110 PTC heating element
111 PTC element
112 Electrical contact
113 Insulation layer
120 PTC heating element
121 PTC element
122 Electrical contact
123 Molding
130 PTC heating element
131 PTC element
132 Radiator

1. A PTC heating element for an electric heating device comprising
at least one PTC element, wherein at least one electrode is provided on a surface of the PTC element for electrically contacting the PTC element,
at least one further contact for electrical connection of the electrode of the PTC element,
at least one carrier layer, the carrier layer being electrically insulating,
wherein a thickness of the PTC element is ≤500 μm and wherein a height of the PTC heating element is between 500 μm and 2500 μm.

2. The PTC heating element according to claim 1,
wherein a lateral dimension of the PTC heating element in both directions is between 10 mm and 250 mm.

3. The PTC heating element according to claim 1,
wherein the at least one electrode is provided in an areal manner on the surface of the at least one PTC element.

4. The PTC heating element according to claim 1,
wherein in each case at least one electrode is provided on a top side and/or a bottom side of the PTC element and/or wherein electrodes are provided on side surfaces of the PTC element.

5. The PTC heating element according to claim 1,
wherein the at least one electrode is strip-shaped, rectangular, comb-shaped or formed as an interdigital structure and/or wherein the electrode is sputtered, galvanized, printed or doctored onto the surface of the PTC element.

6. The PTC heating element according to claim 1,
wherein the further contact is self-supporting or wherein the further contact is sputtered, printed or doctored onto the carrier layer.

7. The PTC heating element according to claim 1,
wherein the further contact is integrated into the carrier layer and wherein the further contact is arranged ≤50 μm below a surface of the carrier layer.

8. The PTC heating element according to claim 1,
wherein a geometry of the further contact is adapted to a geometry of the electrode of the PTC element.

9. The PTC heating element according to claim 1,
wherein a thickness of the further contact is ≤10 μm.

10. The PTC heating element according to claim 1,
wherein the at least one further contact is electrically conductively connected to the at least one electrode by means of clamping, bonding, sintering or high-temperature soldering.

11. The PTC heating element according to claim 1,
wherein the carrier layer comprises a ceramic material with high thermal conductivity and/or a temperature-resistant plastic.

12. The PTC heating element according to claim 1,
wherein the carrier layer comprises AlN, Si₃N₄, Al₂O₃, or SiC and/or wherein the carrier layer comprises polyimide or epoxy resin.

13. The PTC heating element according to claim 1,
wherein the carrier layer has a thickness between 150 μm and 1000 μm.

14. The PTC heating element according to claim 1,
further comprising at least one metallic layer on a surface of the carrier layer for further contacting of the PTC heating element.

15. The PTC heating element according to claim 14,
wherein the metallic layer has a thickness between 1 μm and 100 μm.

16. The PTC heating element according to claim 1,
wherein the at least one PTC element comprises a ceramic material, a metallic-ceramic material or an organic-ceramic material.

17. The PTC heating element according to claim 1,
wherein a material of the at least one PTC element has a low specific resistance.

18. The PTC heating element according to claim 1,
wherein the at least one PTC element comprises a bismuth and lead-free material.

19. The PTC heating element according to claim 1,
wherein the at least one PTC element is a low temperature PTC element.

20. The PTC heating element according to claim 1,
wherein a thickness of the PTC element is ≤250 μm.

21. The PTC heating element according to claim 1,
wherein the at least one PTC element and/or the at least one carrier layer is formed plane-parallel.

22. The PTC heating element according to claim 21,
wherein the at least one PTC element has a plane parallelism of ≤100 μm and/or wherein the at least one carrier layer has a plane parallelism of ≤500 μm.

23. The PTC heating element according to claim 1,
wherein the at least one PTC element is at least partially embedded in the carrier layer.

24. The PTC heating element according to claim 1,
comprising a plurality of PTC elements, wherein a cavity between two successive PTC elements is filled with a temperature-resistant filler material.

25. The PTC heating element according to claim 1,
comprising a plurality of PTC elements, wherein a cavity between two successive PTC elements is filled with an electrode for electrical contacting of the respective PTC element.

26. The PTC heating element according to claim 25,
wherein contacting of the respective PTC element takes place from an end face of the PTC element.

27. The PTC heating element according to claim 1,
comprising a plurality of further contacts, the respective further contact being in the form of a strip.

28. The PTC heating element according to claim 27,
wherein the further contacts are provided alternately on a top side and a bottom side of the PTC elements.

29. The PTC heating element according to claim 1,
further comprising at least one connecting element for electrical connection between the at least one PTC element and the at least one further contact.

30. The PTC heating element according to claim 29,
wherein the at least one connecting element is strip-shaped.

31. The PTC heating element according to claim 29,
comprising a plurality of connecting elements, the respective connecting element being provided at least between the respective further contact and the respective electrode of the PTC element.

32. The PTC heating element according to claim 29,
wherein the at least one connecting element comprises a conductive adhesive.

33. An electric heating device comprising
at least one PTC heating element according to claim 1,
at least one component with heat-emitting surfaces.

34. A use of the PTC heating element according to claim 1 in a motor vehicle.
